(19) United States
(12) Patent Application Publication
(10) Pub. No.: US 2026/0326736 A1
(43) Pub. Date: Oct. 22, 2026

(54) Modular Low Noise Silencers for Commercial Vehicles

(71) Applicant: KNORR-BREMSE SYSTEME FÜR NUTZFAHRZEUGE GMBH, Muenchen (DE)

(72) Inventors: Richard SOMODI, Helvecia (HU); Yves COMPERA, Garching bei Muenchen (DE); Tamas TOTH, Kecskemet (HU); Otto LOERINCZI, Budapest (HU)

(21) Appl. No.: 19/111,209

(22) PCT Filed: Aug. 8, 2023
(86) PCT No.: PCT/EP2023/071952

§ 371 Date: Mar. 12, 2025

(30) Foreign Application Priority Data
Sep. 13, 2022 (EP) 22195256.7

(51) Int. Cl. B60T 17/00; F15B 21/00

(52) U.S. Cl. CPC B60T 17/008; F15B 21/008

(57) ABSTRACT

A silencer for compressed air systems has an inlet opening for a compressed gas flow, a first sound damper arranged downstream of the inlet opening, a second sound damper arranged downstream of the first sound damper, and a grid arranged downstream of the second sound damper. The grid has at least two passages through which the compressed gas flow is adapted to leave the silencer. The first sound damper has a smaller diameter compared to the second sound damper. The second sound damper has at least a portion with higher density compared to the first sound damper. Such an improved silencer is able to perform a noise dampening adapted to specific requirements, and hence to reach lower noise values compared to systems of prior art.

### CROSS REFERENCE TO RELATED APPLICATIONS

This application contains subject matter related to U.S. application Ser. No. ______, entitled “Silencer With Skirt for Compressed Gas Systems,” filed on even date herewith (Attorney Docket No. 107791.PI620US) and U.S. application Ser. No. ______, entitled “Improved Silencer for Compressed Gas Systems,” filed on even date herewith (Attorney Docket No. 107791.PI622US).

### BACKGROUND AND SUMMARY

The present invention relates to a modular silencer, in particular for achieving low noise in a compressed air system in a commercial vehicle.

Systems working with compressed gas, for example compressed air systems, can release large amounts of compressed gas into the environment within a short time. This depressurization of the gas can result in remarkable noises. However, noise emissions have to be kept below an admissible level, and hence, silencers for systems of compressed gas are usually necessary.

In commercial electric vehicles, the largest part of the noise is generated by the mixing of a high velocity air flow with ambient air.

In the prior art, document WO 2019/063350 A1 is known, disclosing a noise damper for compressed air systems with an inlet channel and a chamber for receiving sound-damping material. In this case, the inlet channel and the chamber are separated perpendicular to the compressed air flow by a separation plate, which in an outer peripheral region of the compressed air flow has a plurality of openings in order to introduce compressed air into the chamber. Such a noise damper has a dampening function for noises created by a flow of compressed air, e.g. in a valve releasing compressed air.

For electric commercial vehicles with a pneumatic brake system, a very low noise is of extreme importance. Presently, a valve assembly through which compressed air flows should fulfill the requirement of at most 72 dB(A) in 7 m distance, according to ISO R362 and EEC92/97 and ECE R51.

However, for an electric commercial vehicle with pneumatic brakes (for which the electric motor is very silent compared to other engines, the noise value of at most 72 dB(A) in 7 m distance is still too high.

Hence, there is a need for novel silencers, which are able to reduce a noise emission to below 68 dB(A), or more preferably below 60 dB(A) within 7 m distance from the vehicle.

Hence, the technical problem of the present application can be seen in providing an improved silencer, which is able to perform a noise dampening adapted to specific requirements (e.g. technical guidelines, standards), and hence to reach lower noise values compared to systems according to the prior art.

In particular, externally generated noise, e.g. created by a valve which exhausts compressed air to the atmosphere, should be dampened, as the most prominent part of the noise is generated by the mixing of the compressed air (flowing with a high velocity with the ambient air).

The technical problem of the present application is solved by a silencer and the use of a silencer according to the independent claim(s). Further advantageous embodiments of the present application are the subject-matter of the dependent claims.

A silencer according to the present invention comprises: an inlet opening for a compressed gas flow, a first sound-damper, being arranged downstream of the inlet opening, and a second sound-damper, being arranged downstream of the first sound-damper. A grid is arranged downstream of the second sound-damper, which comprises at least two passages through which the compressed airflow is adapted to leave the silencer. Herein, the first sound-damper has a smaller diameter compared to the second sound-damper, and the second sound-damper has at least a portion with higher density compared to the first sound damper means.

That means that the second sound-damper can have a portion with the same density as the first sound-damper (e.g. downstream of the first sound-damper), but also a portion with a higher density compared to the first sound sound-damper (e.g. upstream of the grid).

In particular the second sound-damper increases the surface area of the outflow of the compressed gas, in particular compressed air, in order to reduce a turbulence intensity of the outflow.

The grid drives the flow to be as homogenous as possible, and further increases the surface area of the outflow in order to reduce the turbulence intensity of the outflow.

An effect of such a configuration is that the flow velocity over the surface can be reduced. The whole surface of the sound damper is increased. Still, axial space can be saved, i.e. by the low diameter of the first sound-damper.

By changing the diameter and the density of the first sound-damper and the second sound-damper, there is a change in the noise level. In general, there is a high velocity of the gas flow through the silencer. The energy of the created noise correlates with said velocity. By a silencer according to the present invention, the velocity of the flow can be reduced, as the surface of the silencer is increased, in particular by the second sound-damper.

The first sound-damper has a lower diameter (compared to the second sound-damper), which results in a lower cross-sectional area, being available for the flow of compressed air. Furthermore, the use of material with a lower density (compared to the second sound-damper) results in the fact that there is less solid, but more voids, microchannels, etc. available for flow. After the transition to the second sound damper, a higher density is present (i.e. material with more solid, but less voids, microchannels, etc. available for flow)—at least in one portion—, however, this is compensated by the higher diameter (i.e. higher cross-sectional area). As a result, the flow velocity is reduced, and there is a smooth transition (with a low flow resistance from the first sound-damper to the second sound-damper. The high density portion of the second sound-damper improves the homogeneity of the flow as the higher density helps to improve distribution in the second mesh, which is of specific importance when the air leaves the silencer. By this arrangement, the flow resistance can be kept at the same level in the whole silencer.

Preferably, the first sound-damper has an equal or smaller height compared to the second sound-damper. As the second sound-damper can have a higher height, a flow with reduced velocity through the height of the second sound-damper can be ensured (with a longer residence time), hence the sound-damping properties being further improved.

Preferably, an intermediate element is arranged between the first sound-damper and the second sound-damper.

The intermediate element can serve for a proper distribution between the two sound-dampers by distributing the flow.

Hence, the flow from the first sound-damper to the second sound-damper can be distributed in a more homogeneous way. The distribution element can be pushed into the second mesh or included in the second mesh.

However, the intermediate element can also have the function to separate the first sound-damper and the second sound-damper and hold them in their respective housings.

Preferably, the first sound-damper and/or the second sound-damper comprise a fibrous material, preferably a fiber mesh, even more preferably a fiber mesh comprising polyethylene.

Such materials serve for an effective damping of noise created by compressed gas, in particular compressed air.

Preferably, the cross-section of the at least two passages in the grid is polygonal, or preferably hexagonal, or alternatively round.

By a hexagonal arrangement, the space can be used in a most effective way. For such hexagonal shape of the passages, the effective flow surface is best, as the residual area by solid grid structure, where dead areas can form, is minimal. Hence, there is an increased ratio from passage area to area covered by solid (i.e. the grid). Hence, such structure allows the highest ratio of the effective flow area over the total grid area. Therefore, the best efflux area can be used for the flow of compressed air over the grid area.

Preferably, the height of the first sound-damper is between 20 and 40 mm. Additionally or alternatively, the height of the second sound-damper is between 20 and 40 mm. Experiments have shown that such heights are most effective for achieving noise levels of below 60 db(A).

Preferably, the diameter of the first sound-damper is at most 65 mm, preferably at most 62 mm, and/or the diameter of the second sound-damper is at least 80 mm, preferably at least 90 mm, more preferably at least 100 mm. It depends on the specific application. Such solution helps to achieve a most effective increase of the surface area of the outflow, hence most efficiently reduced in the turbulence and intensity of the outflow.

Preferably, the at least two passages of the grid have a length of at least 3 mm, preferably between 4 mm and 200 mm, more preferably at least 5 mm, even more preferably at least 7 mm, most preferably at least 10 mm.

The longer the passages are, the higher the effect of the flow homogenization is. In general, passages of at least 3 mm make the flow more homogenous, which can avoid the noise creation by a the flow itself. The passages with a length of at least 3 mm ensure a homogeneous flow of gas, and hence, the turbulence is reduced in the mixing region, where highly pressurized gas is mixed with ambient air.

Hence, passages of at least 3 mm can effectively reduce the noise generated by the mixing of air, which flows out of the chamber and the sound-damper. Passages of at least 3 mm hence contribute to avoid the noise creation by turbulent flows.

Preferably, the cross-sectional area of the at least two passages decreases from the inlet of the passage until portion with smallest diameter, and increases from the portion with smallest diameter towards the outlet of the passage.

The specific shape of the passages mimics a nozzle, which usually has optimized flow characteristics. Such nozzle shape is able to decrease the velocity of the flow.

The specific structure of the cross-sectional area of the at least two passages, which is a streamlined shape, reduces the separation vortices and the drag vortices, which might form after the grid. Such streamlined passages reduce the drag caused by the grid, and also reduce the flow resistance which affects the operation speed of e.g. a pneumatic valve. Furthermore, such streamlined passages can reduce the size and the intensity of the vortices behind the grid (which form as compressed air is mixed with ambient air), and hence reduce the noise energy created by the turbulent flow.

Therefore, an effective reduction of turbulence wakes (vortexes) is possible, in particular by reducing the turbulence intensity in the grid, which is formed by wakes created by the air separation through the grid.

Preferably, the portion of the smallest diameter (for example approximately in the middle of the length of the passages) has a cross-sectional area which is between 80% and 95% of the cross-sectional area of the inlet of the passage and/or the outlet of the passage, preferably above 85%.

Such geometrical constraints mimic the shape of a nozzle. By such shape of the channels, there is a decrease of the velocity of the flow of compressed gas. Such geometrical constraints lead to a low drag at the inlet, and a low wake at the outlet. Furthermore, due to the nozzle shape, the mixing point/region (of pressurized and ambient gas) is moved towards the grid, and the separation wakes decrease regarding their size. Further, the flow cores (velocity profile of flow leaving each channel of grid get broader, leading to very homogenous flow with less turbulence, hence resulting in less noise.

Furthermore, due to the nozzle shape, the mixing point/region (of pressurized and ambient gas) is moved away from the grid, and the separation wakes decrease regarding their size. Further, the flow cores (velocity profile of flow leaving each channel of grid) get broader, leading to very homogenous flow with less turbulence, hence resulting in less noise.

In one embodiment, the inlet of the passage and the outlet of the passage have the same cross-sectional area, which leads to a homogenous flow. The cross-sectional area is the area through which the air flows in the inlet, the outlet or at a length between them.

Preferably, the cross-section area of the passage is larger at the inlet of the passage than at the portion with the smallest diameter and the outside of the passage, the cross-Attorney sectional area of the passage is larger at the outlet of the passage than at the portion with the smallest diameter. By such nozzle design, a very homogenous flow can be guaranteed.

In this case, the passages act as a confusor, focusing the flow at the outlet of the passage.

Alternatively, the cross-sectional area of the passage is larger at the outlet of the passage than at the portion with the smallest diameter and at the inlet of the passage, wherein the cross-sectional area of the passages is larger at the inlet of the passage than at the portion with the smallest diameter

Such design of the nozzle is a diffusor, which also leads to a very rapid pressure reduction, however without generating noise, in particular by moving the mixing zone (of pressurized air and ambient air away from the grid.

Preferably, the first sound-damper is provided in a first housing, and the second sound-damper is provided in the second housing. More preferably, the first housing and the second housing are connectable via a snap-fit connection. Also a bayonet connection or ultrasonic welding is possible.

Such design with different housings allows a modular design of the silencer, wherein a silencer can be custom-built according to specific sound-damping requirements.

The snap-fit connection allows for low installation efforts and an easy maintenance.

Preferably, a sealing is provided in the first housing and the sealing is adapted to seal a connection of the first housing to a housing of a valve. Such configuration helps to avoid the uncontrolled leakage between the silencer and the valve interface.

A preferable use of a silencer according to the present application is the use for a braking system, in particular a braking system of a commercial vehicle.

In the following, preferable embodiments of the present invention are described by the appended figures.

### BRIEF DESCRIPTION OF THE DRAWINGS

FIG. 1a shows a modular design of a silencer, wherein two different sound-dampers are shown.

FIG. 1b shows a similar design compared to FIG. 1a however, the second sound-damper is divided into two portions of different density.

FIG. 2a shows a schematic arrangement of a silencer according to the present application below a valve. Herein, a cross-sectional presentation is shown.

FIG. 2b shows the flow within the silencer 1 of FIG. 2a.

FIG. 3 shows a similar embodiment compared to FIG. 2.

FIG. 4a shows a similar embodiment compared to FIG. 2.

FIG. 4b shows the air flow in such silencer.

FIG. 5a shows another embodiment of a silencer according to the present application, wherein the thickness of an intermediate element is higher compared to FIG. 1 to 4.

FIG. 5b shows the air flow in such a silencer.

FIG. 6 shows a detailed view on a grid.

### DETAILED DESCRIPTION OF THE DRAWINGS

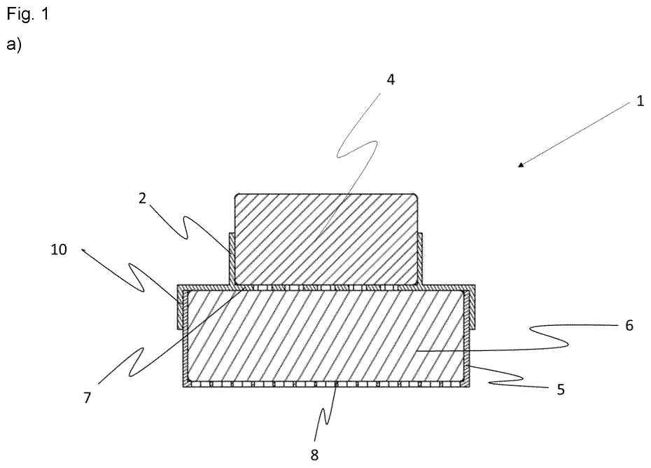

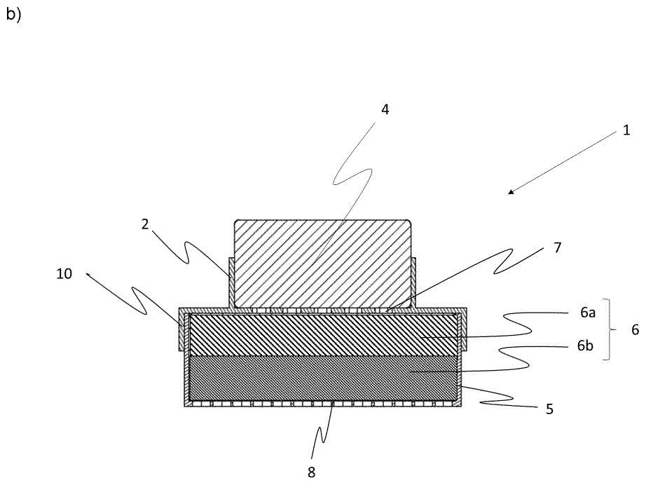

In FIG. 1a, a silencer 1 according to the present application is shown. Herein, there is a first housing 2 and a second housing 5. In the first housing 2, the first sound-damper 4 is provided, and in the second housing 5, the second sound-damper 6 is provided. Between the first sound-damper 4 and the second sound-damper 6, an intermediate element 7 is provided, being a flat plate with several openings. Below the second sound-damper, a grid 8 with several passages 9 is used. There is a snap-fit connection 10 between the first housing 2 and the second housing 5. It can be seen that the diameter of the first sound-damper 4 is smaller compared to the second sound-damper 6. Also, the density of the second sound-damper is higher compared to the first sound-damper 4.

FIG. 1b shows a similar design compared to FIG. 1a; however, the second sound-damper 6 is divided into two portions of different density, an upper portion 6a and a lower portion 6b. The upper portion 6a has a density that is similar to or equal compared to the first sound-damper 4. The lower portion 6b has a higher density compared to the upper portion 6a and the first sound-damper 4.

The lower portion 6b improves the homogeneity of the flow as the higher density helps to improve the flow distribution, which is of specific importance when the air leaves the silencer 1 through the grid 8.

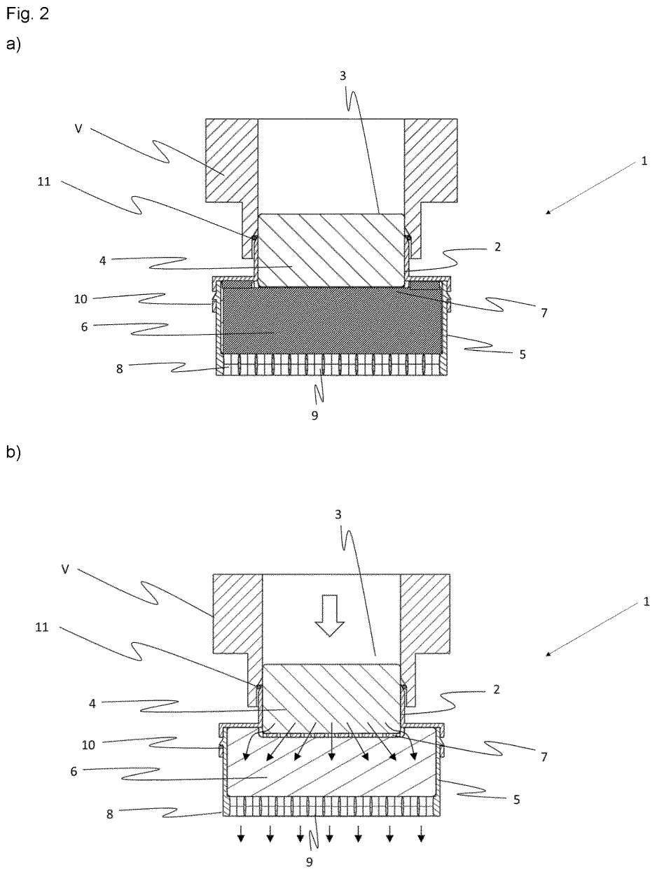

In FIG. 2a, an arrangement of the silencer 1 according to the present application in the valve V is shown. At the outlet of the valve V, the inlet opening 3 of the silencer 1 is arranged, and directly downstream of the inlet opening 3, the first sound-damper 4 is provided. Below the first sound-damper 4, an intermediate element 7 is provided, similarly to FIG. 1. Below the intermediate element 7, the second sound-damper is provided, and below the second sound-damper 8, a grid 8 with several passages 9 is provided. There is a snap-fit connection 10 between the first housing 2 and the second housing 5, and on the first housing 2, there is a sealing 11 in order to connect to the valve housing V. The first sound-damper 4 protrudes into the second sound-damper 6 to some extent. FIG. 2b shows the flow within such a silencer 1. The different densities of the first sound-damper 4 and the second sound-damper 6 are not presented in FIG. 2b. It can be seen that the compressed air flows in a downward-radial direction after the intermediate element 7, however a bit curved in the outer radial portion of the first sound-damper 4, protruding into the second sound-damper 6.

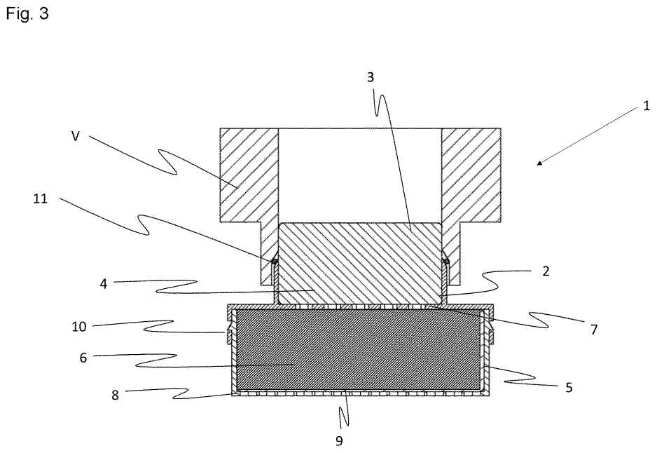

In the embodiment of FIG. 3, the grid 8 with the passages 9 is thinner compared to FIG. 2. The first sound-damper 4 does not protrude into the second sound-damper 6 in this embodiment.

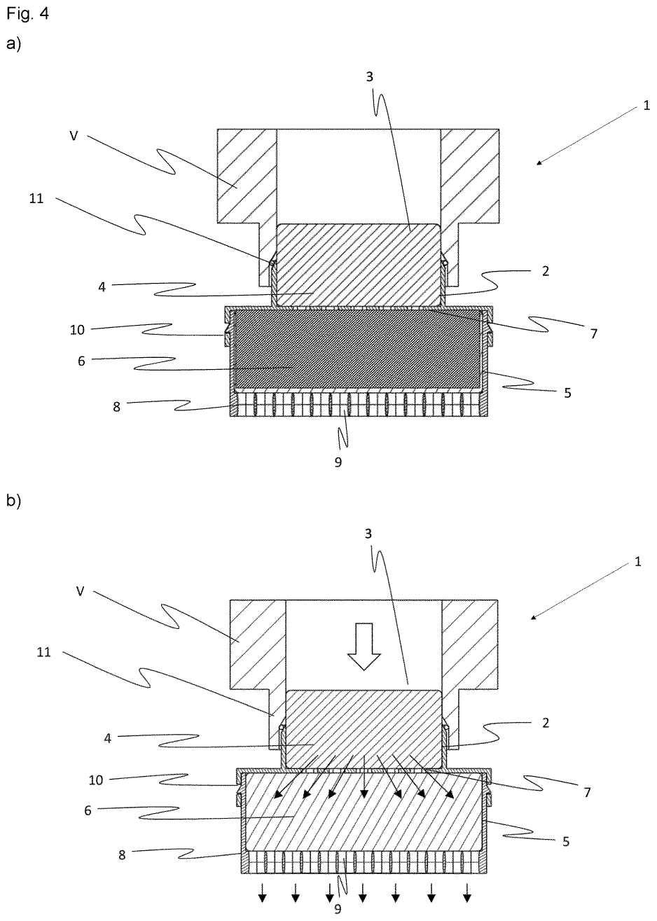

In the embodiment of FIG. 4a, the grid 8 with the passages 9 is thicker compared to FIG. 3. The first sound-damper 4 does not protrude into the second sound-damper 6 in this embodiment. FIG. 4b shows the flow within such a silencer 1. The different densities of the first sound-damper 4 and the second sound-damper 6 are not presented in FIG. 4b. It can be seen that the compressed air flows in a downward-radial direction after the intermediate element 7.

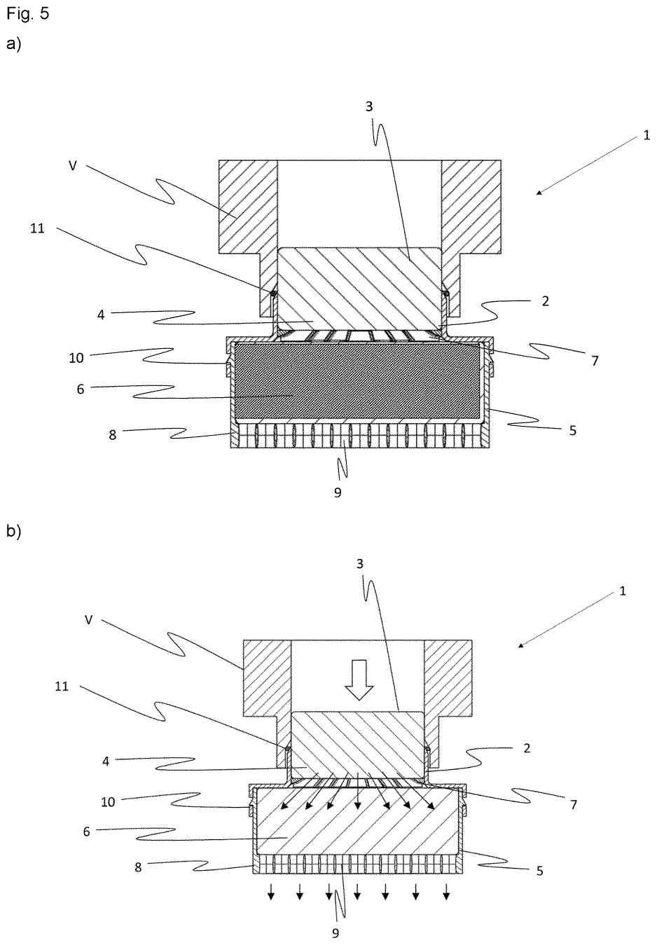

In the embodiment of FIG. 5a, the intermediate element 7 has a specific shape, being thicker and having tapered passages. The first sound-damper 4 does not protrude into the second sound-damper 6 in this embodiment. FIG. 5b shows the flow within such a silencer 1. The different densities of the first sound-damper 4 and the second sound-damper 6 are not presented in FIG. 5b. It can be seen that the compressed air flows in a downward-radial direction after the intermediate element 7. The tapered openings of the intermediate element 7 scatters the air flow within the second sound-damper 6.

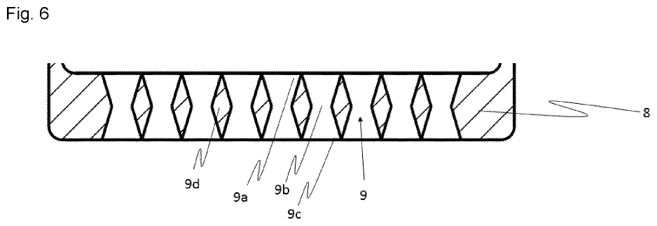

FIG. 6 shows a detailed view of one example of a grid 8. Each passage 8 has an inlet 9a, a portion with the smallest diameter 9b, and an outlet 9c; hence, the cross-sectional area decreases from the inlet 9a until the portion with the smallest diameter 9b, and then increases again until the outlet 9c. The passages 9 have a polygonal cross-sectional area (and shape). The cross-section of walls 9d between the passages 9 has a rhomboid shape.

However, also round or oval cross-sectional areas of the passages 9 are possible.

The first sound-damper 4 and the second sound-damper 6 can for example be connected by gluing or welding (e.g. to the intermediate element 7).

The first sound-damper 4 and the second sound-damper 6 can be fabricated by rolling a mesh. The upper and lower part of the mesh can for example be knitted in one step (with a variation of the density, and the diameter of the rolled mesh increases while rolling). In this case, no intermediate element 7 would be needed.

### LIST OF REFERENCE SIGNS

1 Silencer
2 First housing
3 Inlet opening
4 First sound-damper/mesh
5 Second housing
6 Second sound-damper/mesh
6a upper portion
6b lower portion
7 Intermediate element
8 Grid
9 Passage
10 Snap-fit connection
11 Sealing
V Valve housing

1.-16. (canceled)

17. A silencer for compressed air systems, comprising:
an inlet opening for a compressed gas flow;
a first sound damper arranged downstream of the inlet opening;
a second sound damper arranged downstream of the first sound damper;
a grid arranged downstream of the second sound damper, the grid comprising at least two passages through which the compressed gas flow is adapted to leave the silencer,
wherein the first sound damper has a smaller diameter compared to the second sound damper, and
wherein the second sound damper has at least a portion with a higher density compared to the first sound damper.

18. The silencer according to claim 17, wherein the first sound damper has an equal or smaller height compared to the second sound damper.

19. The silencer according to claim 17, further comprising:
an intermediate element arranged between the first sound damper and the second sound damper.

20. The silencer according to claim 17, wherein
the first sound damper and/or the second sound damper comprises a fibrous material.

21. The silencer according to claim 20, wherein
the first sound damper and/or the second sound damper comprises a fiber mesh or a fiber mesh comprising polyethylene.

22. The silencer according to claim 17, wherein
a cross-section of the at least two passages of the gird is polygonal, hexagonal, or round.

23. The silencer according to claim 17, wherein
a height of the first sound damper is between 20 mm and 40 mm, and/or a height of the second sound damper is between 20 mm and 40 mm.

24. The silencer according to claim 17, wherein
a diameter of the first sound damper is at most 65 mm, and/or the diameter of the second sound damper is at least 80 mm.

25. The silencer according to claim 24, wherein
a diameter of the first sound damper is at most 62 mm and/or the diameter of the second sound damper is at least 100 mm.

26. The silencer according to claim 17, wherein
the at least two passages have a length of between 4 mm and 200 mm.

27. The silencer according to claim 26, wherein
the at least two passages have a length of at least 10 mm.

28. The silencer according to claim 17, wherein
the cross-sectional area of the at least two passages respectively decreases from the inlet of the passage until a portion with a smallest diameter, and increases from the portion with smallest diameter towards the outlet of the passage.

29. The silencer according to claim 17, wherein
the portion with smallest diameter of the at least two passages has a cross-sectional area between 80% and 95% of the inlet of the at least two passages and/or the outlet of the at least two passages.

30. The silencer according to claim 17, wherein
the inlet of the at least two passages and the outlet of the at least two passages have the same cross-sectional area.

31. The silencer according to claim 17, wherein
the cross-sectional area of the at least two passages is larger at the inlet than at the portion with smallest diameter and the outlet of the at least one passage, and
the cross-sectional area of the at least two passages is larger at the outlet than at the portion with smallest diameter.

32. The silencer according to claim 17, wherein
the cross-sectional area of the at least two passages is larger at the outlet than at the portion with smallest diameter and the inlet and
the cross-sectional area of the at least two passages is larger at the inlet of the at least two passages than at the portion with smallest diameter.

33. The silencer according to claim 17, wherein
the first sound damper is provided in a first housing,
the second sound damper is provided in a second housing, and
the first housing and the second housing are connectable via a snap-fit connection.

34. The silencer according to claim 17, wherein a seal is provided at the first housing, the seal being adapted to seal a connection of the first housing to a housing of a valve.

35. Use of a silencer according to claim 17 for a braking system of a commercial vehicle.
